(19) United States
(12) Patent Application Publication
(10) Pub. No.: US 2006/0146906 A1
(43) Pub. Date: Jul. 6, 2006

(54) LLP EUV drive laser

(75) Inventors: Daniel J.W. Brown, San Diego, CA (US); Alexander I. Ershov, San Diego, CA (US); Vladimir B. Fleurov, Escondido, CA (US); Igor V. Fomenkov, San Diego, CA (US); William N. Partlo, Poway, CA (US)

Correspondence Address: William C. Cray;Cymer, Inc., Legal Dept., MS/4-2C, 17075 Thornmint Court, San Diego, CA, 92127-2413, US

(73) Assignee: Cymer, Inc., San Diego, CA (US)

(21) Appl. No.: 11/324,104

(22) Filed: Dec. 29, 2005

Related U.S. Application Data
(63) Continuation-in-part of application No. 10/979,919, filed on Nov. 1, 2004.
(63) Continuation-in-part of application No. 10/781,251, filed on Feb. 18, 2004.
(63) Continuation-in-part of application No. 11/021,261, filed on Dec. 22, 2004.
(60) Provisional application No. 60/657,606, filed on Feb. 28, 2005.

(51) Int. Cl. H01S 3/22; H01S 3/223

(52) U.S. Cl. 372/57

(57) ABSTRACT

An apparatus and method is disclosed which may comprise an EUV drive laser system comprising: a solid state seed laser master oscillator laser; a gas discharge excimer laser gain generator producing a drive laser output light beam. The solid state seed laser may comprise a third harmonic Nd:YLF laser, which may be tunable. The gas discharge excimer gain generator laser may comprise a XeF excimer laser power amplifier or power oscillator. The solid state laser may comprise a tunable laser tuned by changing the temperature of a laser crystal comprising the solid state laser, or by utilizing a wavelength selection element, e.g., a Lyot filter or an etalon.

### RELATED APPLICATIONS

The present application claims priority to U.S. Provisional Patent Application Ser. No. 60/657,606, entitled LPP EUV Drive Laser, filed on Feb. 28, 2005, Attorney docket No. 2004-0107-01, the disclosure of which is hereby incorporated by reference, and is a continuation in part of co-pending U.S. patent application Ser. No. 10/979,919, entitled LPP EUV LIGHT SOURCE, filed on Nov. 1, 2004; and Ser. No. 10/781,251, entitled VERY HIGH ENERGY, HIGH STABILITY GAS DISCHARGE LASER SURFACE TREATMENT SYSTEM, filed on Feb. 18, 2004; and Ser. No. 11/021,261, entitled EUV LIGHT SOURCE OPTICAL ELEMENTS, filed on Dec. 22, 2004, assigned to the assignee of the present application, the disclosures of which are hereby incorporated by reference.

### FIELD OF THE INVENTION

The present invention relates to drive laser systems for a laser produced plasma (“LPP”) extreme ultraviolet (“EUV”) or soft x-ray light source, e.g., for integrated circuit photolithography process applications and other high power high stability uses, e.g., Low Temperature Poly-Silicon formation for, e.g., forming thin film transistors by laser annealing amorphous silicon to form crystallized silicon in which the thin film transistors may be formed, e.g., for flat panel displays and the like.

### BACKGROUND OF THE INVENTION

There is a need for an effective and efficient Laser Produced Plasma (“LPP”) extreme-ultraviolet light (“EUV”, otherwise known as soft X-ray) light source, e.g., for integrated circuit photolithographic uses. Applicants propose certain improvements and modifications to currently available technology.

### SUMMARY OF THE INVENTION

An apparatus and method is disclosed which may comprise an EUV drive laser system comprising: a solid state seed laser master oscillator laser; a gas discharge excimer laser gain generator producing a drive laser output light beam that has a sufficently high spatial beam quality so that it can be relatively stratightforwardly focused to a relatively small spot, as will be understood by those skilled in the art. The solid state seed laser may comprise a third harmonic Nd:YLF laser, which may be tunable. The gas discharge excimer gain generator laser may comprise a XeF excimer laser power amplifier or power oscillator. The solid state laser may comprise a tunable laser tuned by changing the temperature of a laser crystal comprising the solid state laser, or by utilizing a wavelength selection element, e.g., a Lyot filter or an etalon.

### BRIEF DESCRIPTION OF THE DRAWINGS

FIG. 1 shows an energy level diagram for XeF, from: W. D. Kimura, et al., Appl. Opt.#21, Vol. 28 (1989);

FIG. 2 illustrates schematically an EUV drive laser system according to aspects of an embodiment of the present invention and the measurement of the output spectrum according to aspects of an embodiment of the present invention;

FIG. 3 output spectra from an EUV drive laser such as that of FIG. 2;

FIG. 4 illustrates schematically an EUV drive laser system, according to aspects of an embodiment of the present invention;

FIG. 5 illustrates an output spectrum from an EUV drive laser system such as that of FIG. 4;

FIG. 6 illustrates a desired shifting of the spectrum from a solid state seed laser for an EUV drive laser system with the natural operating free running spectrum of a solid state Nd:YLF laser otherwise displaced from two spectral peaks for a XeF excimer gas discharge laser system according to aspects of an embodiment of the present invention;

FIG. 7 shows a graph illustrating an optimization of MO spectral performance, e.g., with a Lyot filter, whereby two Nd:YLF lines, e.g., two consecutive Nd:YLF lines overlap with respective strong line peaks of a XeF spectrum according to aspects of an embodiment of the present invention.

FIG. 8 further illustrates a spectrum relating to a solid state EUV drive laser system seed laser, e.g., a 3-rd harmonic Nd:YLF MO according to aspects of an embodiment of the present invention, e.g., further showing spectroscopic measurements illustrating that a 3-rd harmonic Nd:YLF laser needs to be tuned to match XeF gain spectrum;

FIG. 9 further illustrates an output wavelength of 3-rd harmonic Nd:YLF laser being shifted to match 351.125 nm line of XeF gain spectrum and the resultant PA output spectrum;

FIG. 10 illustrates energy scaling, e.g., to increase XeF gain, generator efficiency and output energy according to aspects of an embodiment of the present invention;

FIG. 11 illustrates graphically long term operation@400W per PA channel demonstrated at 4 kHz with a 100% DC;

FIG. 12 illustrates and example of a 200 million pulses run, performed on high repetition rate XeF MOPA system, e.g., with a single-pass PA;

FIG. 13 illustrates single pass and triple pass efficiency in a PO amplifier laser portion;

FIG. 14 illustrates an MOPO laser system arrangement according to aspects of an embodiment of the present invention and a scheme for evaluating its performance;

FIG. 15 illustrates an evaluation of a PO configuration whereby an efficient PO seed has been demonstrated, according to aspects of an embodiment of the present invention;

FIG. 16 illustrates temporal pulse width, e.g., at FWHM, for a MOPO, a single pass PA and a triple pass PA;

FIGS. 17 and 18A and 18B are illustrative of XeF MOPA beam divergence, with FIG. 17 shows an experimental set up wherein far field profiles, e.g., for a XeF MOPA beam divergence are determined;

FIGS. 18A and 18B show the beam profiles as measured, e.g., according to the setup of FIG. 17;

FIGS. 19A and 19B show lithium and tin spectra from plasma source materials for varying laser irradiation intensities;

FIG. 20 is illustrative in graph format, by way of example, of the variation of plasma source size with laser intensity in two dimensions along with measured conversion energy; and,

FIGS. 21 A and 21B illustrate graphically, by way of example, conversion energy angular distribution.

### DETAILED DESCRIPTION OF PREFERRED EMBODIMENTS

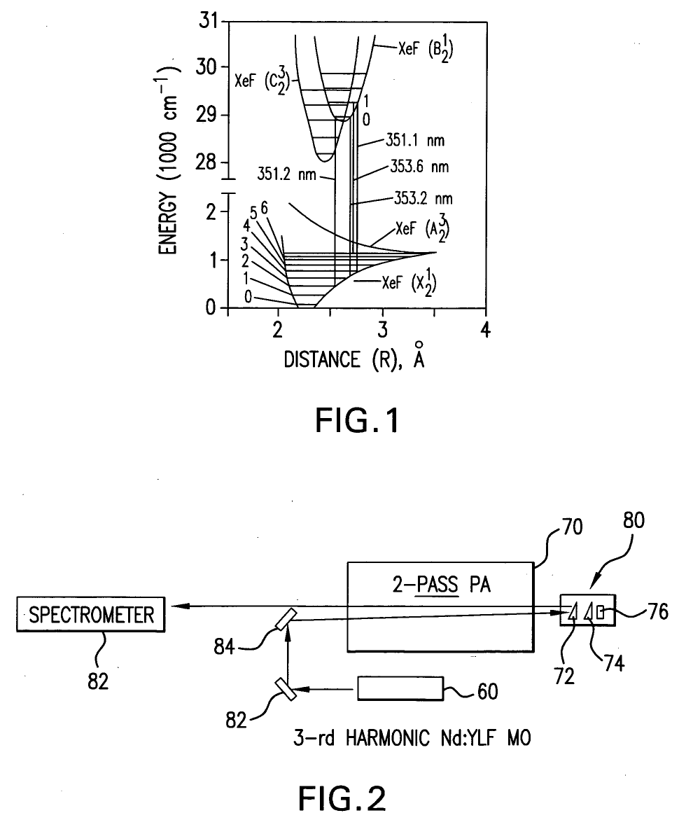

FIG. 1 illustrates an energy level diagram for XeF, from: W. D. Kimura, et al., Appl. Opt.#21, Vol. 28, 1989. Regarding the spectral characteristics of a XeF gain media, the ground state of XeF is bounded, i.e., it forms a molecule at a relatively low temperature. The XeF radiative life time is ˜16 ns.

Applicants propose improvements relating to the efficiency and beam quality of a laser system, e.g., an excimer gas discharge laser system, e.g., a XeF high power laser system, useful, e.g., for a laser produced plasma (“LPP”) extreme ultraviolet (“EUV”) or soft x-ray light source, e.g., for integrated circuit photolithography process applications and other high power high stability uses, e.g., Low Temperature Poly-Silicon (“LTPS”) formation for, e.g., forming thin film transistors by laser annealing amorphous silicon to form crystallized silicon with larger elongated crystals wherein the thin film transistors may better be formed, e.g., for flat panel displays and the like. The improvements also relate to economic issues such as cost reduction, e.g., through increased system life and reduction in the cost of consumables, e.g., optical elements and laser chambers.

The use of a solid state laser, e.g., a diode pumped 3-rd harmonic Nd:YLF master oscillator (MO), e.g., coupled with a gas discharge excimer amplifier laser, e.g., a XeF power amplifier (“PA”) or power oscillator (“PO”) allows, e.g., the design of a kW-level MOPA or MOPO system, e.g., with an output beam that has sufficently high spatial beam quality so that it can be relatively stratightforwardly focused to a small spot, as will be understood by those skilled in the art. A challenge to be addressed may be to provide efficient amplification of the solid state seed laser, e.g., the Nd:YLF-based MO beam in an amplifier medium, e.g., the XeF-media in either a power amplifier or power oscillator configuration (“MOPA”), “MOPO”). This is due, mainly to a mismatch between operating the wavelength of, e.g., the running Nd:YLF source and the XeF gain, as illustrated, e.g., in FIG. 6. This graph illustrates a typical output spectrum 30, e.g., from a Q-switched 3^{rd} harmonic Nd:YLF oscillator and amplified stimulated emission (ASE) spectrum 120 from a gas discharge chamber filled with XeF laser media. The output of spectrum 30 of the Nd:YLF laser, e.g., may be shifted towards shorter wavelengths by ˜120 pm compared to the nearest strong line 34 of XeF gain spectrum 120, peaked at ˜351,126 pm. There is also a second strong line 36, positioned at ˜351,268 pm.

In order to, e.g., provide more optimum conditions for efficient operation of XeF amplifier laser, e.g., in a power amplifier configuration, the output of the 3^{rd} harmonic Nd:YLF MO may, e.g., be shifted towards longer wavelengths and broadened, e.g., to amplify at both peaks 34, 36 of the XeF amplifier laser. Thus, at the same time, the spectral width/shape of solid state MO output is proposed to be maintained to overlay two strong lines 34, 36 of XeF gain peaked at ˜351.126 nm and ˜351.268 nm respectively.

This required modification of spectral features of Nd:YLF output according to aspects of an embodiment of the present application may be done, e.g., because the width of Nd:YLF crystal gain is wide enough to accommodate spectral shift within a ˜420 pm range, e.g., the fluorescence spectrum of Nd:YLF is ˜±1.4 nm, e.g., @FWHM in accordance with the literature. Applicants propose to achieve this by, e.g., increasing the temperature of Nd:YLF crystal and/or an introducing wavelength selective element(s) in the laser resonator such as etalon, Lyot filter, diffraction grating, or their combination.

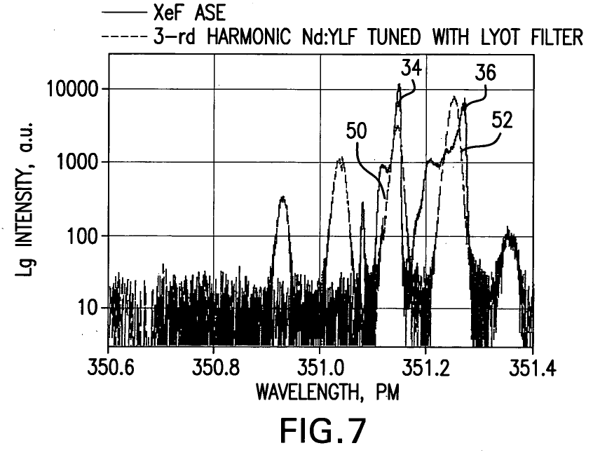

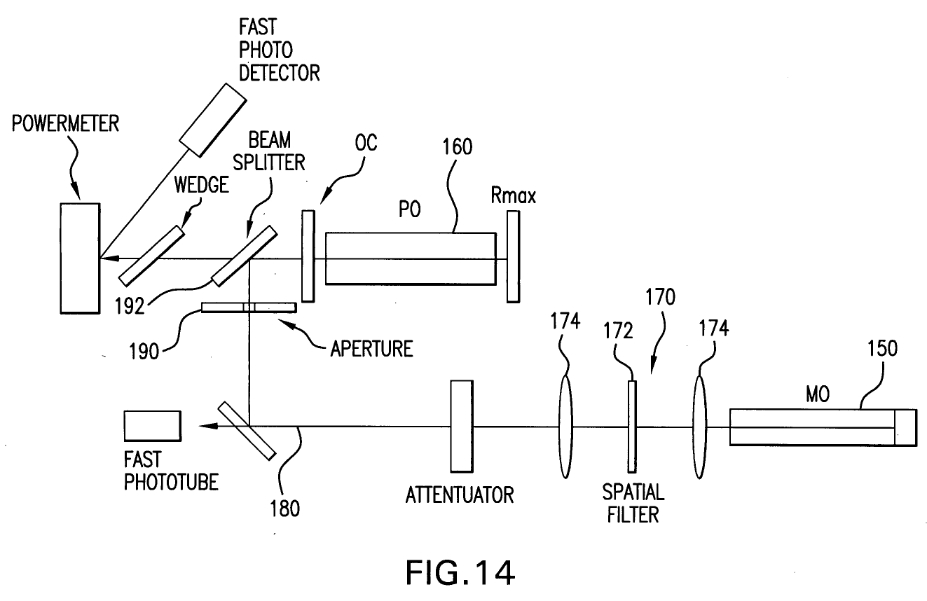

In addition, applicants propose further improvement, e.g., in coupling between, e.g., an Nd:YLF MO module and, e.g., the XeF PA/PO module, e.g., by using a two-line or multi-line MO oscillator, to produce a double-line MO output, e.g., that matches both 351.126 nm and 351.268 nm XeF gain lines more optimally. To achieve this requirement applicants propose, e.g., using an intracavity etalon, e.g., with FSR=3*Δλ, where Δλ(˜142 pm), or by using a Lyot filter, with proper spectral characteristic, e.g., a single plate Lyot filter with a birefringence that creates the desired split of the output of, e.g., a solid state seed laser, e.g., an Nd:YLF that ultimately produces, e.g., after frequency multiplication, the desited two peaks overlapping, e.g., the strong lines of the XeF excimer laser amplification, e.g., as shown in FIG. 7, such as a Lyot filter plate well known in the art. Simulation of the multi-line regime of Nd:YLF output, e.g., produced by a single plate intra-cavity Lyot filter, e.g., as shown in FIG. 14 is shown in FIG. 7. FIG. 7 illustrates conditions where the wavelength separation between two consecutive spectral lines 50, 52 of the 3^{rd} harmonic Nd:YLF output matches the above noted XeF strong gain lines.

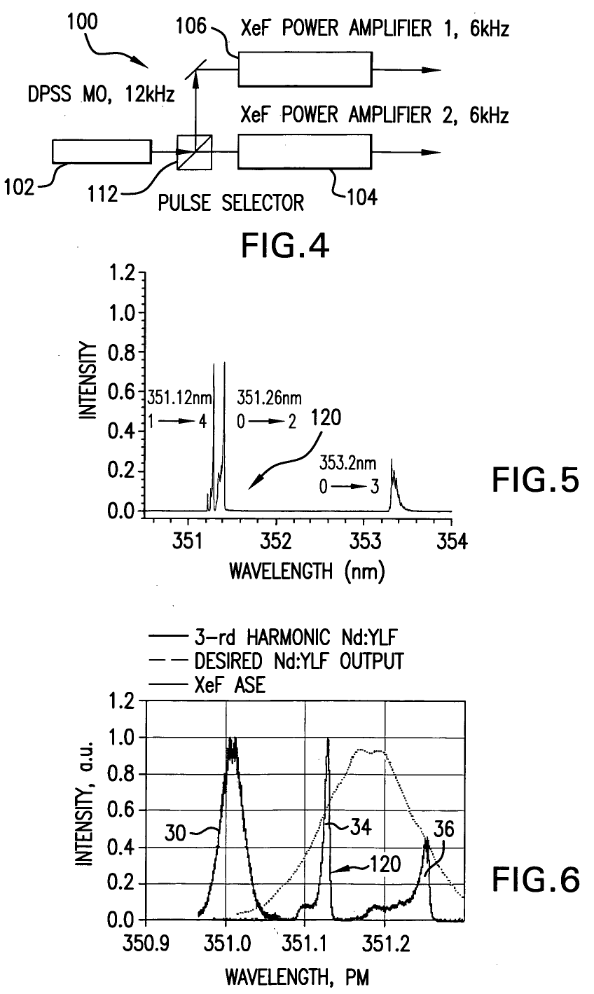

Applicants have examined the feasibility of amplification of the laser beam produced by the commercially available 3_{rd} harmonic Nd:YLF laser in the XeF gas discharge gain module. For example a production-grade excimer laser chamber, e.g., filled with a Xe:F₂:Ne gas mixture and was excited by using a production-grade pulse power module, e.g., from applicant's assignee's single chamber laser system, e.g., an ELS 6010 series laser. A commercial Q-switched diode pumped 3_{rd} harmonic Nd:YLF laser, e.g., a Photonics Industries International (model DS10-351) may be used as the MO 102 as illustrated schematically in FIG. 4. Pulse synchronization between the solid-state MO 102 and the excimer laser chambers 104 and 106 of the gain module, as illustrated by way of example in FIG. 4 may be provided, e.g., using a Stanford delay generator (DG-535) 112. The output beam from the MO 102 may be expanded, e.g., in the vertical direction, e.g., with a prism beam expander, e.g., prisms 72, 74 illustrated in FIG. 2, e.g., to match the cross-section for the discharge of the gain module, e.g., PA 70 illustrated in FIG. 2 or PA's 104 or 106 illustrated in FIG. 4. A single-pass PA optical configuration has been used for experimentation by applicants.

A proposed drive laser system for LPP EUV source is illustrated in FIG. 4, using, e.g., a single flame two-channel hybrid system, which may, e.g., utilize a portion of applicant's assignee, Cymer Inc.'s XLA MOPA multi-chamber laser system platform, which may also be an amplifier portion of, e.g., a MOPO multichamber laser system. For example, two gas discharge excimer gain modules 104, 106 may be seeded by the high repetition rate solid-state (e.g., 12 kHz) master oscillator 102. Such a two-channel approach can, e.g., allow high repetition rate operation while the gas flow limited excimer gain laser modules 104, 106 may be allowed to operate at half the repetition rate of the MO 102, e.g., at 6 kHz. The optical architecture of the system can utilize master oscillator-power amplifier (MOPA) or master oscillator-power oscillator (MOPO) configurations. The MO 102 may be a high beam quality, high repetition rate diode pumped laser. The MO may then, e.g., operate at doubled repetition rate to seed XeF power gain modules in alternating sequence through the pulse selector 112.

One of the advantages of the system according to aspects of an embodiment of the present invention is that, e.g., it can use a very robust, high power XeF gain module, developed on proven excimer laser technology. Another advantage of such a system can be, e.g., that it can implement a cost efficient diode pumped MO, e.g., with sufficiently high spatial beam quality so that it can be relatively stratightforwardly focused to a small spot, as will be understood by those skilled in the art. The MO laser 102 may be a frequency tripled Nd:YLF (third harmonic) laser, e.g., operating at 351 nm wavelength. Commercially available 3_{rd} harmonic Nd:YLF lasers, are capable of operating at high repetition rates, e.g., exceeding 10 kHz and can deliver near diffraction limited beam quality, e.g., with a M² parameter close to 1.

The spectroscopic measurements of Amplified Spontaneous Emission (ASE) in 351-353 nm range are shown in FIG. 5. The energy of ASE pulses was measured to be approximately 30 ml, indicating, e.g., that the spectrum in FIG. 5 corresponds to a gain saturated condition. As can be seen in, e.g., FIG. 5 and partly in expanded scale in FIGS. 6-9, there are three strong ASE lines, associated with the 351.1 nm (v=1-4), 351.2 nm (v=0-2), and 353.2 nm (v=0-3) transitions within the B-X XeF manifold of the XeF molecule, e.g., as illustrated in FIG. 1. This observation is in a good agreement with spectroscopic data on XeF.

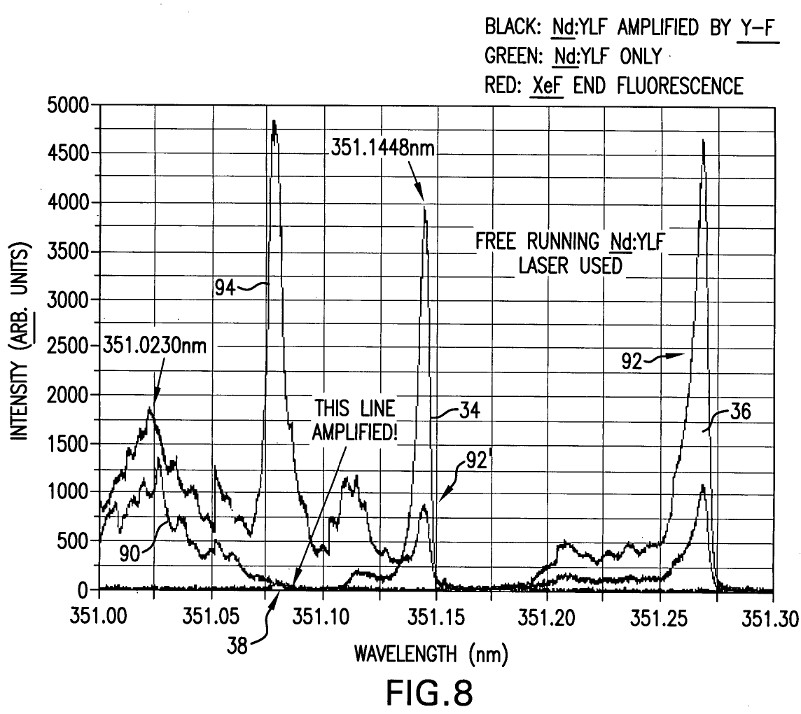

As illustrated, e.g., in FIG. 8, these same three spectra, along with the MOPA output spectrum 92, the spectrum of the solid state MO acquired through the PA module 94; and the ASE spectrum 34, e.g., taken when the MO beam was blocked. The spectral bandwidth of the “free running” 3rd harmonic Nd:YLF MO is approximately 40 pm wide (FWHM) and the central wavelength may is shifted to the shorter wavelength region in respect with the PA ASE spectrum 34. The ASE spectrum 34 of the PA as illustrated barely overlaps with the tail of the MO spectrum 92. There is also a dramatic difference between the ASE spectrum and the MOPA output spectrum, e.g., due to single-pass amplification of the MO beam in the PA). Due to the high gain values in XeF media, however, applicants have shown that even a very small fraction of MO energy, contained in the overlapping parts of the MO and PA spectra 92, 34 may be strongly amplified by XeF gain generator, i.e., forming spectrum 94. As a result, the energy extraction from the PA can be seen to occur mostly on the weak lines 38 on the shorter wavelength side of the spectrum 34.

The FIG. 8 spectral measurements on the MOPA set up, e.g., as illustrated in 4, e.g., with a 1-pass PA, 104, 106, may be made, e.g., using a Q-switched 3rd harmonic Nd:YLF MO 102 producing a spectrum 92 measured, e.g., at PA (XeF gain module) 104, 106 input, from the ASE output measured at PA output with the MO blocked, 34, 36, and a single pass PA output 94, seeded by the Q-switched harmonic Nd:YLF MO. The MO pulse energy was measured to be: ˜1 mJ, and pulse duration ˜50 ns (FWHM).

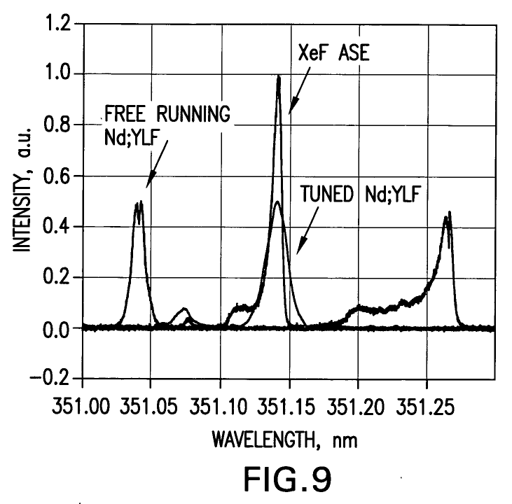

In particular, a weak 351.08 nm line 38, which is, as can be seen, e.g., in FIG. 8, barely traceable in the ASE spectrum of the excimer laser, can be made to become amplified approximately 100 times, e.g., in a single pass PA, e.g., 104, 104, as illustrated in FIG. 4. To extract even more energy from the strong 351 nm XeF emission lines and to provide better PA efficiency, e.g., the MO output may need, e.g., better spectral overlap with the XeF gain lines 34, 36. Applicants have found that at least two emission lines, e.g., 34, 36 of the XeF gain may need to be seeded for sufficient energy extraction. The 1053 nm fluorescence line of Nd:YLF crystal is approximately 1.5 nm wide, making it feasible to seed both XeF lines, e.g., centered at 351.12 nm and 351.24 nm, e.g., as illustrated in FIGS. 6-9, e.g., with a single 3rd harmonic Nd:YLF source. Experimental results on the tunability of the 3rd harmonic Nd:YLF laser, e.g., 60 illustrated in FIG. 2 or 102, illustrated, e.g., in FIG. 4, are shown in FIG. 9. These results demonstrate, e.g., a stable operation of the 3rd harmonic Nd:YLF laser output with wavelength tuned to match the 351.12 nm line.

FIG. 9 illustrates a demonstration of wavelength tunability of a 3rd harmonic Nd:YLF MO, e.g., 60 or 102, e.g., to match a XeF gain line, e.g., at 351.12 nm. The bandwidth of 1053 nm Nd:YLF fluorescence line is shown also to be sufficient to seed also the 351.25 nm line of XeF, e.g., in FIG. 6.

The number of passes in the gain module may not be able to be significantly increased above a triple-pass PA scheme, e.g., due to physical constraints of the system. Therefore, applicants have determined that, according to aspects of an embodiment of the present invention about 2 mJ of MO pulse energy may be needed for practical MOPA design. The use of Master Oscillator Power Oscillator (MO-PO) approach, therefore, according to aspects of an embodiment of the present invention may offer another method for further reduction of the required MO pulse energy. A possible set up of the MOPO configuration is shown illustratively in FIG. 14. The MO 150 and PO 160 XeF gain modules may be based on the same gas discharge chamber technology as the MOPA configurations described above. A spatial filter 170 may be used to improve beam quality of the MO output, e.g., beam quality(ies) such as, e.g., focusability and spatial beam qualities.

The spatial filter 170 may be formed by a small aperture placed in a focal plate 172 of a telescope 174, e.g., consisting of two spherical lenses. After the spatial filter 170, an optical attenuator 160 can be used to adjust the amount of MO 150 energy injected into the PO 160 cavity. Before the MO 150 output beam 180 is injected into the PO cavity 160 it may be directed through an aperture 190 and thereby, e.g., shaped to match the PO 160 discharge cross section. The coupling of MO 150 output beam 180 into PO resonator 160 may be done through a partial reflector, e.g., beam splitter 192. Optical isolation between MO 150 and PO 160 may be achieved, e.g., by introducing a long optical delay between MO 150 and PO 160. The MO 150 energy can be measured before the PO output coupler. The MOPO energy can be measured after the beam splitter 192 and corrected for the beam splitter 192 transmittance. A maximum PO energy extracted was determined to be ˜82 mJ which is comparable with the MOPA. The maximum extraction efficiency was determined to be ˜3.4%, which is higher compared to MOPA results. An important advantage of the MOPO system can be that it requires much lower MO output energy compared to the MOPA configurations.

A comparative evaluation of the temporal pulse shape at the output of MOPA for single- and triple-pass PA configurations, as well as at the output of MOPO was conducted. Pulse waveforms for the MOPA and MOPO configurations are shown in FIG. 16, illustrating a MOPO spectrum 200, single pass PA spectrum 202 and triple pass spectrum PA 204. Temporal pulse shapes for the three configurations, MOPO, MOPA one pass and MOPA triple pass. Pulse width values τ, e.g., measured @ FWHM as illustrated τMOPO˜17.3 ns, τMOPA single pass, and τMOPA triple pass ˜12.7 ns. The measurements were performed at trigger delay between MO and PA(PO) modules, corresponding to maximum output energy. A comparison between the MOPA and MOPO pulse shapes shows that the shortest pulse duration is generated with a triple pass PA configuration. Approximately 1 ns difference is observed in the pulse width (FWHM) for the single-pass and triple-pass PAs. The longest pulse width is generated by the MOPO set up. This result is consistent with pulse width data which applicants' company Cymer has observed for the line narrowed MOPA and MOPO ArF systems. If necessary, a reduction of the pulse width could be achieved by reducing the gas discharge duration.

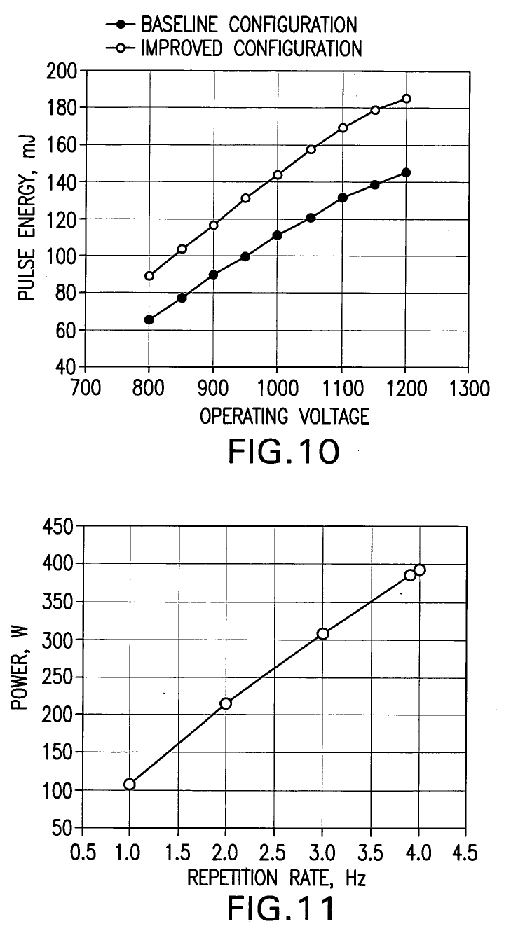

Applicants have achieved significant progress in the technology development of XeF gain modules. A key challenge for the discharge chamber is meeting the high average power requirement. Core chamber technology used in applicants' assignees XLA multi-chamber, e.g., MOPA systems have been proved to work reliably at 4 kHz, 100% DC, in such systems (and have been expanded to 6 kHz), the former producing an average power of ˜400W per module, as illustrated, e.g., in FIG. 11. In order to achieve a 1200W system power requirement the pulse repetition rate has been increased to 6 kHz and the pulse energy to ˜200 mJ. Improvements in gas flow technology have resulted in about a 40% reduction in the motor power required for the maximum lasing gas circulation flow speeds, one of the keys to achieving 6 kHz in a chamber that is essentially the same size as an XLA 4 kHz chamber. FIG. 10 illustrates improvements in energy extraction. A 34% increase in energy extraction has been demonstrated.

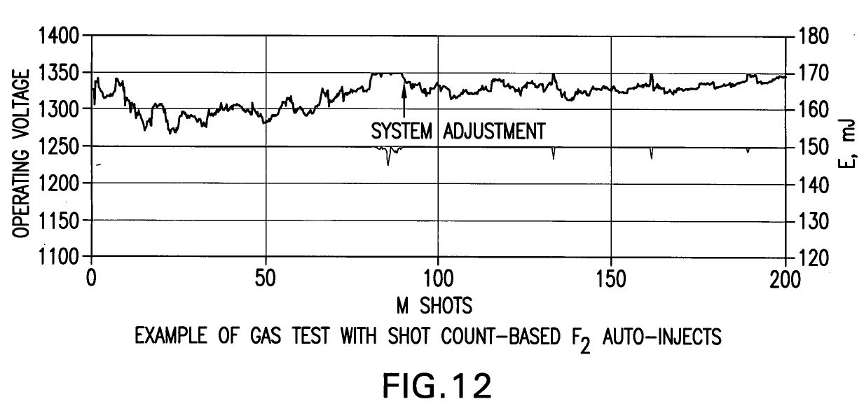

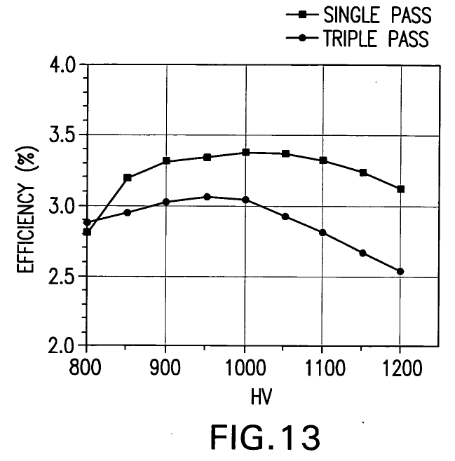

An example of a 200 million pulses run, performed on high repetition rate XeF MOPA system, e.g., with a single-pass PA, is illustrated in FIG. 12. Such a MOPA system used by applicants' employer for reliability tests uses production-grade 4 kHz chambers, similar to the chambers in the ELS-7010 DUV products. It can operate at 100% DC, producing up to 800W of the output power. During a gas lifetime test the system was demonstrated to generate 150 mJ output pulses at 4 kHz, 100% DC. A simple pulse-count based gas inject algorithm can be implemented to maintain the operating voltage within required range.

Multiple 200M shot runs in 600-800W power range have bee demonstrated to show the most critical modules of the MOPA system. Pulse energy density and average power density on output optical components have been experienced to exceeded 0.5J/cm² and 1.7 kW/cm² levels. No failures were observed on either reflective or transmissive optical elements.

The approaches described above will work for MOPO system as well. The minimal energy requirements for the MO laser in such a case are further significantly reduced.

According to aspects of an embodiment of the present invention an efficient LW or LTPS oscillator-amplifier system, e.g., a MOPA system can consist of a solid-state master oscillator (MO) and XeF gas discharge power amplifier (PA). A further advantage of such a system is the combination of the beam quality parameters of the solid-state laser seed beam and the high energy and short pulse duration of the excimer amplifier output, e.g., in a PA configuration. Applicants propose, e.g., that the MO comprise a diode-pumped solid state laser (DPSS) to provide a beam with has sufficiently high spatial beam quality so that it can be relatively stratightforwardly focused to a small spot, as will be understood by those skilled in the art, and with high pointing stability, such a laser may comprise a 3-rd harmonic Nd:YLF MO laser for a XeF PA amplifier module.

The gain spectrum of XeF media has a three-branch structure as illustrated in FIG. 1 with three emission branches at around 351.1, 351.2 and 353.6 nm respectively, each of which has a structure due, e.g., to vibration levels of the molecule.

An efficient UV MOPA system that consists of a solid-state master oscillator (MO), e.g., 60 illustrated in FIG. 2 or 102 illustrated in FIG. 4 and, e.g., a gas discharge amplifier laser, e.g., a XeF gas discharge power amplifier (PA), e.g., as shown in FIG. 2 or 4 or a power oscillator (PO) illustrated, e.g., in FIG. 14. An advantage of such a system may be, e.g., that it combines beam qualith parameters of the solid-state laser beam and high energy and short pulse duration of the excimer PA output. Preferable choice for the MO approach is a diode-pumped laser (DPSS) to provide a beam with has sufficiently high spatial beam quality so that it can be relatively stratightforwardly focused to a small spot, as will be understood by those skilled in the art, as well as high pointing stability.

A proper choice for XeF PA is a 3-rd harmonic Nd:YLF MO laser, that closely matches spectral properties of XeF excimer gain media, see patent disclosure by W. Partlo and D. Brown, 2004.

The gain spectrum of XeF media has three-branch structure and is shown in the FIG. 1.

The operating wavelength of a Nd:YLF laser is offset, but can be tuned, e.g., to match two strong 351 nm lines of XeF power amplifier/oscillator, e.g., using a selective cavity as noted above. However, there is another strong XeF gain line at around 353 nm that cannot be seeded with the same MO. Since the gain values in excimer laser media are very high, efficient seeding of the PA 70 with an MO 60 beam, e.g., at around 351 nm can only be achieved according to aspects of an embodiment of the present invention if the significant gain branch at around 353 nm is suppressed. Otherwise, the beam quality and efficiency of the system can be compromised.

According to aspects of an embodiment of the present invention applicants propose to provide a configuration of, e.g., a MOPA system which consists of a solid state seed laser, e.g., a third harmonic Nd:YLF MO and a power amplifier laser, e.g., a dual or multi-pass XeF PA or a power oscillator laser as the amplifier portion, e.g., with a wavelength selector, e.g., to suppress amplified stimulated emission (ASE) at 353 nm and to provide good beam quality and efficient operational regime of the amplification at around 351 nm.

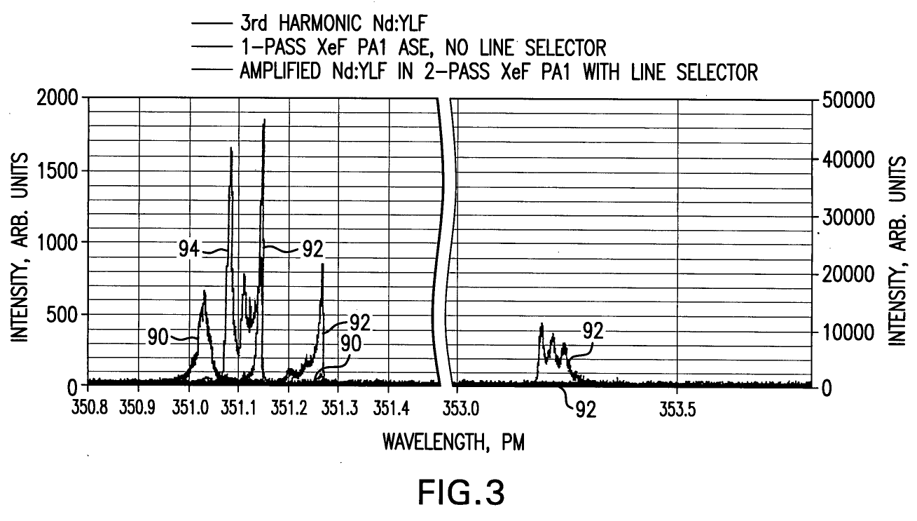

Turning now to FIG. 2 there is illustrated an experimental set up according to aspects of an embodiment of the present invention wherein, e.g., a MOPA set up with, e.g., a DPSS third harmonic Nd:YLF MO 60 and a 2-pass gas discharge XeF PA 70, e.g., with a wavelength selector 80, otherwise known as a line selection unit. Using, e.g., a standard gas discharge chamber form, e.g., a chamber previously used in applicants' assignee's EXL-6000 system products as the PA 70, e.g., filled with Xe—F₂—Ne lasing gas mixture. The 3^{rd} harmonic Nd:YLF MO 60 did not have selective elements in the cavity and was producing a broad spectrum 60 (˜30-40 nm@FWHM) which is offset in respect to the PA gain, as shown at 30 in FIGS. 6 and 92 in FIG. 3. The wavelength filtration in the PA 70 can be performed, e.g., after the first beam pass through the PA 70. Two prisms 72, 74 and one retro-mirror 76 can be used to form a wavelength selector 80 on the right side of PA 70. When the MO 60 output beam was blocked, the ASE spectrum 92 at PA 70 output showed all three strong gain branches, i.e., two at around 351 nm (v 0-2 and v 1-3 transitins) and one at around 353.2 nm (v 0-3 transition). In an amplification regime, the MO 62 spectrum 60 does not have to coincide exactly with the gain lines around 351 nm PA 70, due to high amplification.

As one can see in the FIG. 8, even a partial overlap between MO 62 spectrum 92 and PA 70 output spectrum 34 can have had sufficiently efficient PA 70 seeding. Only a small fraction of the MO energy in the spectrum 92 is sufficient to saturate both 351 nm branches of PA 70. Also, it is important no note that the weaker lines 38 in the left wing of XeF ASE spectrum, at about 351.075 nm can become very strongly amplified. Seeded by a well-collimated MO 60 beam, the PA 70 output 94 remains also well collimated. The 353 nm branch(es) can be suppressed, which proves the approach. Development of a drive laser with sufficient output power, high beam quality, and economical cost of consumables is critical to the successful implementation of a laser-produced plasma (LPP) EUV source or LTPS applications for high volume manufacturing (“HVM”) applications.

According to aspects of an embodiment of the present invention applicants have researched a number of solutions to this critical need. A high power laser system, using two gas-discharge power amplifiers and repetition rates up to 12 kHz to produce more than 2 kW output power with high beam quality is proposed. Optical performance data, design features of the drive laser and output power scaling issues have been addressed and according to aspects of an embodiment of the present invention solutions are proposed. Applicants believe that such a system can be achieved meeting the following exemplary parameters of operation: (1) drive laser wavelength at around 351 nm; (2) power at about 2.4 kW per laser module; (3) pulse Energy at about 200 mJ; (4) pulse repetition rate 6-12 KHz; (5) pulse duration ˜10 ns and (6) beam quality (a) divergence at about 90% encircled integrated energy at <200 uRad and (b) pointing stability at about ˜20 mRad; (6) integral energy stability (˜0.3%), 3s for window=100 pulses; (7) laser efficiency at about ˜4%.

According to aspects of an embodiment of the present invention a suitable laser architecture may comprise a high repetition rate operation, e.g., based upon a two channel approach with two 6 kHz, 100% duty cycle (“DC”) gain modules. Both MOPA and MOPO optical schemes may be employed. High beam quality and 12 kHz repetition rates may be provided by, e.g., solid state diode pumped master oscillator.

Turning now to FIG. 4 there is shown a laser system 100, which, according to aspects of an embodiment of the present invention may comprise a diode pumped solid state laser, e.g., an Nd:YLF laser 102 which can be operated, e.g., at 12 KHz with a 100% DC to supply 6 KHz seed pulsed to each of a first amplifier laser, e.g., an XeF amplifier laser 104 and a second amplifier laser, e.g., a XeF amplifier laser 106, each, e.g., being in a single or multiple pass amplifier arrangement and supplied in a tic-toc fashion by a beam selector 110, each delivering, e.g., 100 mJ per PA channel, i.e., 800W.

Turning now to FIGS. 8 and 9 there is illustrated spectra relating to a 3^{rd} harmonic Nd:YLF MO according to aspects of an embodiment of the present invention, e.g., with FIG. 8 showing spectroscopic measurements illustrating that a 3^{rd} harmonic Nd:YLF laser needs to be tuned to match a XeF gain spectrum, and FIG. 9 showing an output wavelength of a 3^{rd} harmonic Nd:YLF laser being shifted to match, e.g., 351.125 nm line of XeF gain spectrum and the resultant PA output spectrum. As shown in FIG. 8, the output spectrum 92 of a free running 3^{rd} harmonic Nd:YLF only slightly overlaps with a portion 34 of the XeF gain spectrum and also that an ˜100x energy amplification in XeF PA output spectrum can be achieved using the free running 3^{rd} harmonic Nd:YLF with the spectrum 92. Also the XeF PA seeded by Nd:YLF MO has been shown to be comparable with XeF PA efficiency seeded by a XeF MO.

Turning now to FIG. 10 there is shown an illustration of energy scaling as part of an effort by applicants to increase XeF gain, generator efficiency and output energy, including optimization of the chamber and pulse power designs. The maximum energy output so far achieved is around 180 mJ, with 200 mJ achievable with currently existing chamber technology. FIG. 11 illustrates graphically long term operation @ 400W per PA channel demonstrated at 4 kHz with a 100% DC.

FIG. 12 illustrates graphically XeF MOPA testing at 9.7×10⁹ (one billion) pulses. Life test conditions at 351 nm, 4 kHz, 100% DC, 600-800W power range have indicated a gas life of ˜200×10⁶ shots, which matches well with current DUV production systems. No damage of optics has so far been observed.

Turning now to FIG. 14 there is illustrated graphically MOPA extraction efficiency, wherein with a single pass PA extraction the efficiency is close to 3.5% and with a 3-pass XeF PA extraction the efficiency exceeds 3%. The extraction efficiency of the three pass PA is lower than for a single pass, but with a single pass around 30 mJ needs to be input to the PA for about the same overall output as about 1 mJ input to the 3 pass PA due to the amplification occurring in each of the three passes.

Turning now to FIG. 14 there is illustrated the results of a series of experiments performed including relating to optimization of MOPO cavity, evaluation MO energy requirements and pulse duration.

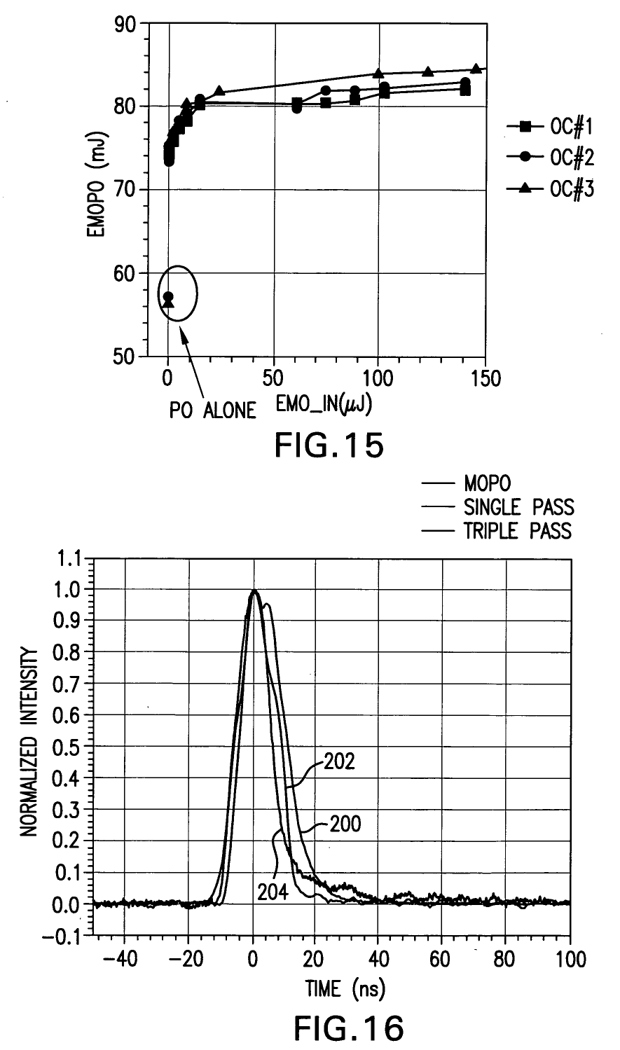

FIG. 15 illustrates an evaluation of a PO configuration whereby an efficient PO seed has been demonstrated and 85 mJ MOPA output has been achieved. MO seed energy requirements have been shown to be ˜30 uJ and various configurations of PO may be utilized, as will be understod by those skilled in the art.

FIG. 16 provides and illustration of temporal pulse width, pulse width (FWHM) for a MOPO 200 shown to be 17.3 ns, a single pass PA 202 shown to be 13.9 ns and a triple pass PA 204 shown to be 12.7 ns.

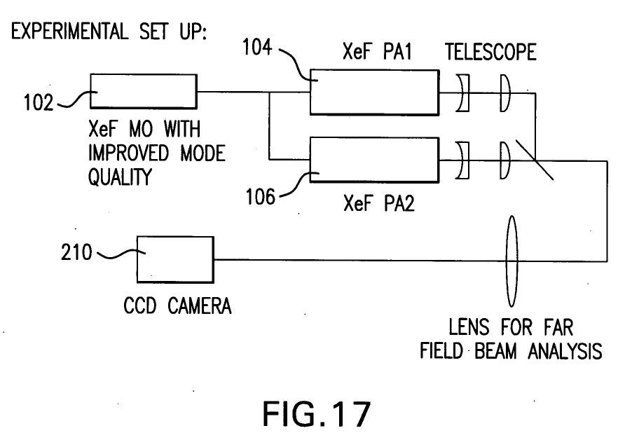

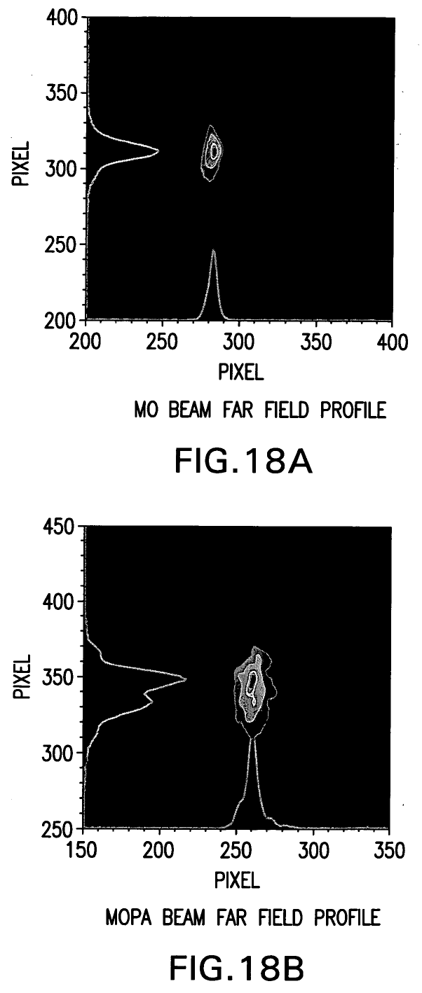

FIGS. 17 and 18A and 18B are illustrative of measuring XeF MOPA beam divergence and the results, with FIG. 17 showing an experimental set up wherein far field profiles can be acquired with, e.g., a CCD camera at minimal spot and FIGS. 18 A and 18B show the beam profiles. MOPA beam divergence has been shown to be determined by MO 102 beam divergence as illustrated in FIGS. 18A and 18B and Table II below.

TABLE II

| | | HD, μRad | | VD, μRad |
|---|---|---|---|---|
| | HD, | 75% | VD, | 75% |
| | μRad | Energy | μRad | Energy |
| | FWHM | Integral | FWHM | Integral |
| MO | 30 | 130 | 80 | 150 |
| PA | 70 | 90 | 70 | 120 |

Applicants have successfully developed a 351 nm drive laser concept for an LPP EUV system based on, e.g., two XeF Power Amplifiers 102, 104 driven by a 3^{rd} harmonic Nd:YLF Master Oscillator 102. To achieve efficient amplification the MO pulses may be tuned by ˜0.5 nm from the center of Nd:YLF emission spectrum for proper overlapping with XeF gain. Two basic architectural approaches, MOPA and MOPO, systems have been evaluated, using high power XeF laser technology. Both XeF MOPA and XeF MOPO have demonstrated adequate optical performance. MOPO has demonstrated the lowest MO seed energy to meet output power requirement (˜30 uJ), while MOPA has demonstrated a shorter pulse duration and greater flexibility for beam quality optimization, e.g., in the MO. 10¹⁰ pulses of operation of a MOPA system has been was demonstrated at a 600˜800W power range. No significant optics damage issues have been discovered were observed. Future development of the drive laser can include optimization of the beam quality, extension of operating repetition rates to 8 kHz, increase of output energy and power and system efficiency.

Efficient conversion of laser light into EUV radiation is one of the most important problems of the laser-produced plasma (LPP) EUV source. A too low conversion efficiency (CE) increases the amount of power the drive laser will have to deliver, which, besides the obvious laser cost increase, also increases the thermal load on all the components and can lead to increased debris generation. In order to meet the requirements for a high-volume manufacturing (HVM) tool and at the same time keep the laser power requirements within acceptable limits, a CE exceeding 2.5% is likely to be required. Applicants propose certain aspects according to embodiments of the present invention relating to optimizing conversion efficiency of LPP EUV generation. The optimization parameters include laser wavelength, target material, and laser pulse shape, energy and intensity. The final choice between parameter sets that leads to the required minimum CE may be affected by or ultimately determined by debris mitigation solutions and the laser source available for a particular parameter set.

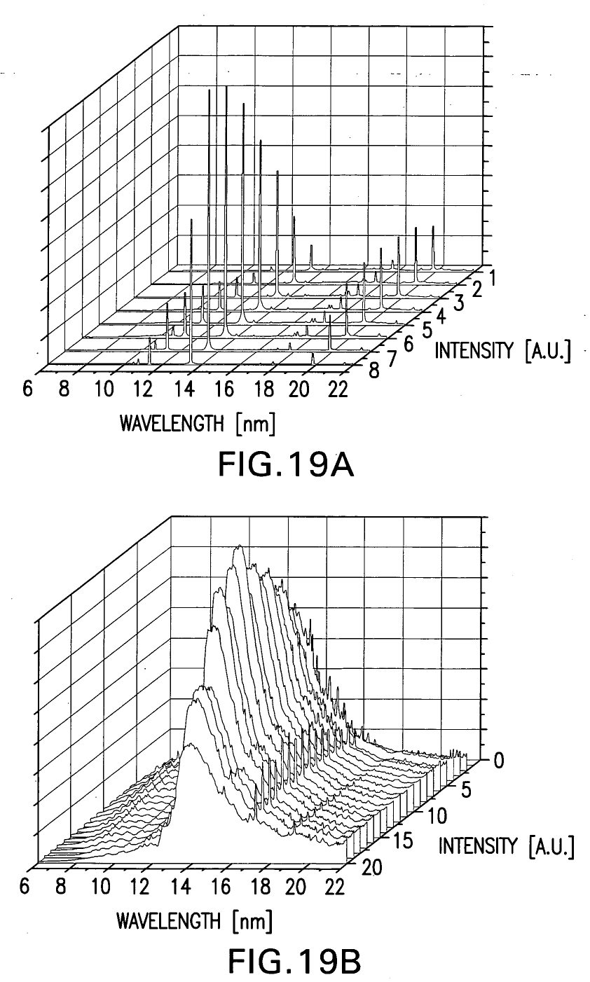

FIGS. 19A and 19B show lithium and tin spectra from plasma source materials for varying laser irradiation intensities.

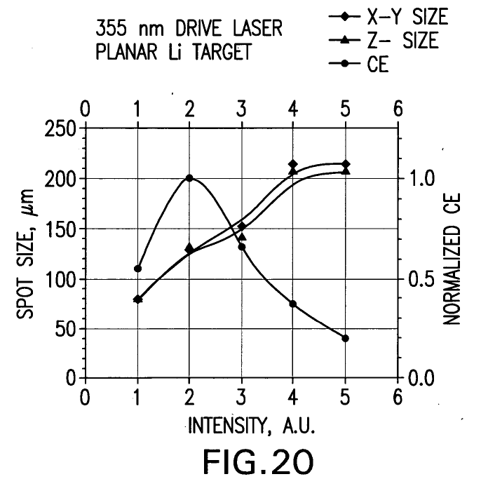

FIG. 20 is illustrative in graph format of the variation of plasma source size with laser intensity in two dimensions along with measured conversion energy as further represented by Table IV below.

TABLE IV

| | Laser Wavelength | | | |
|---|---|---|---|---|
| | 355 nm | | 1064 nm | |
| | Drive Laser Energy | | | |
| | E₀ | 2E₀ | E₁ | 2E₁ |
| Best CE | 2.3% | 2.5% | 2.5% | 2.6% |
| XY Source Size at | ˜125 um | ˜130 um | ˜200 um | ˜225 um |
| best CE | | | | |
| Z Source Size at best CE | ˜125 um | ˜120 um | ˜190 um | ˜120 um |

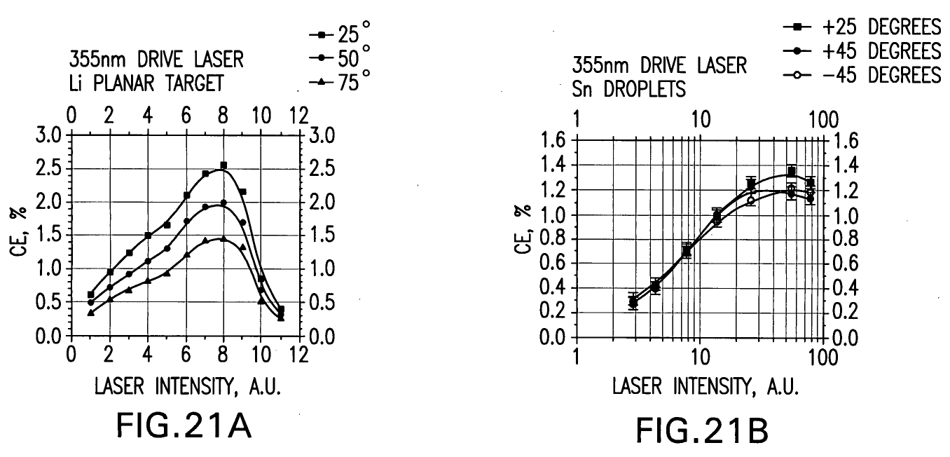

FIGS. 21 A and 21B illustrate graphically conversion energy angular distribution as also summarized in Table V below.

TABLE VI

| | | |
|---|---|---|
| Laser | Li foil | Sn Traget 45°:25° |

| Wavelength | 50°:25° | 75°:25° | Plate | Droplets |
|---|---|---|---|---|
| 355 nm | 0.75 | 0.68 | ˜1 | ˜1 |
| 1064 nm | 0.58 | 0.42 | TBD | TBD |

Applicants have tested various combinations of laser wavelengths, pulse widths, energies, and target materials to find optimal conversion efficiency parameters. It has been shown that lithium produces narrow-line emission well suited for use with Mo/Si multi-layer mirrors. The lithium emission bandwidth is much smaller than the required 2% bandwidth that a next generation microlithography tool will need. In contrast, tin has a board spectrum, which may require a spectral purity filter. The source size of the lithium emission has been shown to be small, and can easily meet the etendue requirements for efficient collection of the emitted light. The source size has a strong dependence on the drive laser wavelength and a weak dependence on the drive laser energy.

The angular distribution measurements reveal better uniformity for tin than for lithium. Comparison of different target geometries reveals increased CE for Sn droplets in comparison to the planar targets. A pre-pulse can lead to a noticeable increase in CE. The conversion efficiency is only one consideration among many for the appropriate choice of drive laser parameters and target material. Ultimately, the initial cost and the cost of operation of the high volume manufacturing tool will dictate which laser/target combination is the best. System tradeoffs might require choosing lower CE options to extend collection optics lifetime.

LPP source geometry exposes the normal incidence collector to a high intensity flux of medium energy (1-10 keV) ions from the target material. Direct damage due to sputtering and implantation severely degrades reflectivity of a multi-layer reflector. Collector lifetime on the ETS (Sandia Nat'l Lab) was limited by ion damage from 1-6 keV Xe ions. Bi-layers were etched at a rate of 1 per 15M pulses. Therefore, any EUV source concept must include an effective means for stopping collector erosion due to damage from fast ions.

An ion energies summary is shown in Table VII below.

TABLE VII

| | | | Max ion | Peak |
|---|---|---|---|---|
| | | YAG laser parameters | energy, eV | ion energy, eV |
| | | 355 nm, 6.4 ns, 160 mJ | 1,100 | 600 |
| | | 355 nm, 8 ns, 540 mJ | 1,100 | 500 |
| | | 355 nm, 1 ns, 100 mJ | 2,700 | 900 |
| Lithium | {open oversize bracket} | 1064 nm, 6.5 ns, 180 mJ | 1,150 | 550 |
| | | 1064 nm, 8.5 ns, 315 mJ | 1,200 | 550 |
| | | 1064 nm, 1 ns, 200 mJ | 3,000 | 650 |
| | | Tin, 1064 nm, 9 ns, 305 mJ | 6,500 | 2,450 |
| Tin | {open oversize bracket} | | | |
| | | Tin, 355 nm, 9 ns, 425 mJ | 5,600 | 1,550 |

The ion flux intensity and energies vary with laser parameters and target material as illustrated in Table VIII below.

TABLE VIII

| | Li (50 μm foil) | | | Sn (50 μm foil) | | |
|---|---|---|---|---|---|---|
| Laser: 355 nm | 25° | 45° | 75° | 25° | 45° | 75° |
| Normalized | 1 | 0.25 | 0.17 | 1 | 0.41 | 0.12 |
| Ion Flux | | | | | | |
| (a.u.) | | | | | | |
| Maximum | 1150 | 650 | 450 | 5500 | 7800 | 20000 |
| Kinetic Energy | | | | | | |
| (eV) | | | | | | |

With regard to collector protection from condensable materials, e.g., a possible HVM technical path can utilize a Li target and, e.g., a heated multi-layer mirror. Condensed lithium can be evaporated from the collector mirror, maintained, e.g., at about 400C. Multi-layer mirror structures with high reflectivity and wavelength stability at high temperature have been developed by applicants' employer, along with highly effective Li diffusion barriers having suitably low EUV absorption, as shown, e.g., in co-pending patent applications noted above. LPP debris, consisting of both moderate energy ions, and condensable neutral material, represents a serious technical challenge for acceptable collector lifetime in a EUV light source. Ion debris has been characterized and different techniques with reasonable ion stopping power have been demonstrated. In parallel, the techniques are expected to reduce ion erosion to a level consistent with 100B shot collector lifetime. Condensable target material, Li, can be evaporated from the collector surface. Technical challenges include (1) development of high temperature MLM mirrors stable in reflectivity and center wavelength under prolonged annealing conditions; (2) development of a suitable and effective Li diffusion barrier.

It will be understood by those skilled in the art that the aspects of embodiments of the present invention disclosed above are intended to be preferred embodiments only and not to limit the disclosure of the present invention(s) in any way and particularly not to a specific preferred embodiment alone. Many changes and modification can be made to the disclosed aspects of embodiments of the disclosed invention(s) that will be understood and appreciated by those skilled in the art. The appended claims are intended in scope and meaning to cover not only the disclosed aspects of embodiments of the present invention(s) but also such equivalents and other modifications and changes that would be apparent to those skilled in the art. In additions to changes and modifications to the disclosed and claimed aspects of embodiments of the present invention(s) noted above the following could be implemented.

We claim:

1. An EUV drive laser system comprising:
a solid state seed laser master oscillator laser;
a gas discharge excimer laser gain generator laser producing a drive laser output light beam.

2. The apparatus of claim 1 further comprising:
the solid state seed laser comprising a third harmonic Nd:YLF laser.

3. The apparatus of claim 2 further comprising:
the solid state seed laser is tunable.

4. The apparatus of claim 1 further comprising:
the gas discharge excimer gain generator laser comprises a XeF excimer laser power amplifier or power oscillator.

5. The apparatus of claim 2 further comprising:
the gas discharge gain generator laser comprises a XeF excimer laser power amplifier or power oscillator.

6. The apparatus of claim 3 further comprising:
the gas discharge excimer gain generator laser comprises a XeF excimer laser power amplifier or power oscillator.

7. The apparatus of claim 4 further comprising:
the solid state laser comprising a tunable laser tuned by changing the temperature of a laser crystal comprising the solid state laser.

8. The apparatus of claim 5 further comprising:
the solid state laser comprising a tunable laser tuned by changing the temperature of a laser crystal comprising the solid state laser.

9. The apparatus of claim 6 further comprising:
the solid state laser comprising a tunable laser tuned by changing the temperature of a laser crystal comprising the solid state laser.

10. The apparatus of claim 5 further comprising:
the solid state laser comprising a tunable laser tuned by utilizing a wavelength selection element.

11. The apparatus of claim 6 further comprising:
the solid state laser comprising a tunable laser tuned by utilizing a wavelength selection element.

12. The apparatus of claim 7 further comprising:
the solid state laser comprising a tunable laser tuned by utilizing a wavelength selection element.

13. The apparatus of claim 10 further comprising:
the wavelength selection element comprises a Lyot filter.

14. The apparatus of claim 11 further comprising:
the wavelength selection element comprises a Lyot filter.

15. The apparatus of claim 12 further comprising:
the wavelength selection element comprises a Lyot filter.

16. The apparatus of claim 10, further comprising:
the wavelength selection element comprises an etalon.

17. The apparatus of claim 11, further comprising:
the wavelength selection element comprises an etalon.

18. The apparatus of claim 12, further comprising:
the wavelength selection element comprises an etalon.
